(19) United States
(12) Patent Application Publication
(10) Pub. No.: US 2016/0379139 A1
(43) Pub. Date: Dec. 29, 2016

(54) ADAPTIVE CLASSIFICATION OF DATA ITEMS

(71) Applicant: SECURE ISLANDS TECHNOLOGIES LTD., Jerusalem (IL)

(72) Inventors: Yuval Eldar, Shoham (IL); Roee Oz, Tel Aviv (IL)

(21) Appl. No.: 15/194,007

(22) Filed: Jun. 27, 2016

Related U.S. Application Data
(60) Provisional application No. 62/185,767, filed on Jun. 29, 2015.

(51) Int. Cl. G06N 99/00; G06F 17/30

(52) U.S. Cl. CPC G06N 99/005; G06F 17/30598

(57) ABSTRACT

Described are embodiments for adaptive classification of data items which may include receiving a classification training set, the classification training set comprising a set of items associated with classification events made by a group of selected users, each item in the set of items having been designated as belonging to a particular classification by a selected user while manipulating the each item; determining from the classification training set a set of rules which can be used to classify unknown data items such that the classification of the unknown data items is consistent with the manual or automatic classification of the classification training set; adaptively updating the set of rules, according to classifications made to additional data items by additional users; and automatically classifying, based on the set of rules, one or more data items that are manipulated by a second set of one or more users.

### CROSS-REFERENCE TO RELATED APPLICATIONS

This application claims priority to and benefit from Provisional Patent Application No. 62/185,767, entitled “METHOD AND SYSTEM FOR AUTOMATIC ADAPTIVE CLASSIFICATION OF DATA ITEMS,” filed Jun. 29, 2015.

### BACKGROUND

Computer systems and related technology are ubiquitous and affect most aspects of modern business, industry, and life. Computer systems' ability to process information has transformed the way we live and work. Computer systems now commonly perform a vast and diverse variety of tasks. Some tasks, prior to the advent of computer systems, were performed manually. Other tasks now routinely performed by and within computer systems were simply impossible prior to computers. In some cases, computer systems have been coupled to one another and to other electronic devices and systems to form both wired and wireless computer networks. Over such networks, computer systems and other electronic devices can share and transfer electronic data and divide and share computing tasks. Common tasks can be performed by shared computing systems and complex tasks can be divided into smaller tasks which can be performed by multiple computing systems. The performance of many computing tasks may be distributed across a number of different computer systems and/or a number of different computing environments. These computing systems and computing environments, in some cases, may be systems and environments which are shared by multiple users and/or shared by multiple organizations. Such shared systems and environments may be available over communication networks or be so-called cloud-based systems.

In addition to data and documents which are generated, stored, and/or archived within one system or organization, the data and documents may also be shared with other systems, organizations, or individuals. Access to data and documents by individuals, systems, or organizations may depend upon the information content of the data and documents and access rights of individuals, systems, or organizations who desire such access. Distribution of data and documents outside a system or organization may also depend upon the information content of the data or documents and rights of both the entity who may receive the data or document and the rights (of distribution) of the entity who desires to distribute the data or documents. Even within a particular system or organization, access to or visibility of particular data and/or documents may be dependent upon the information content of the data and/or documents and rights or individuals or subgroups within the system or organization.

Determining proper access and/or distribution rights may sometimes be problematic, time-consuming, or difficult. Rather than determining access to data or the ability to distribute data on an ad hoc, per data item or document, basis, it may sometimes be useful to classify data or documents so that the assigned classification may be referred to and used to determine proper access, visibility, and/or distribution.

In addition to access, visibility, and/or distribution, classification of data and/or documents may also be beneficial for categorization purposes. A business entity, for example, may want to find all documents in its possession which have something to do with a particular business purpose such as sales or marketing. In another example, an organization may want to find all documents which might pertain to a particular technology area or research focus. In another example, an entity may want to find all data or documents which pertain to a particular individual, organization, customer, or the like. Classification of data and documents may facilitate such searching, sorting, categorization, etc., of the data and documents.

Accordingly, systems, methods, and products for classification of data and documents may be useful and beneficial to a great many individuals, systems, enterprises, and organizations.

### BRIEF SUMMARY

Embodiments presented herein relate to adaptive classification of data items in an enterprise. As noted above, classification may be used to determine proper access, visibility, and/or distribution of data items. Similarly, classification of data items and documents may facilitate such searching, sorting, categorization, etc., of the data and documents. Embodiments presented herein relate to methods, systems, and products which can facilitate the automatic classification of data items and documents such that the resulting classifications may be used by enterprises, individuals, organizations, systems, etc., in whatever beneficial applications which may be useful.

Information classification can be useful in almost in any organization for purposes of allowing better information management. Such purposes include security measurements, access control, information governance (a set of multi-disciplinary structures, policies, procedures, processes and controls implemented to manage information at an enterprise level, supporting an organization's immediate and future regulatory, legal, risk, environmental and operational requirements), business relevance, data categorization, assistance for better knowledge management, storage efficiency, data retention (continued storage of an organization's data for compliance or business reasons). Of course, an enterprise or organization in this context may be any of various and diverse organizations, including government entities and subgroups, educational institutions and organizations, commercial enterprises, charitable and non-profits organizations, etc. Further still, data categorization as described herein may also be used by and be useful to individuals and consumers.

Information classification can be useful in many organizations to enforce encryption, access blocking and other protection methods (like blocking transmissions) on corporate sensitive information from unauthorized access and usage by users. It allows enforcing such protection methods and security policy, based on business value and confidentiality levels or other classification attributes. For example, the security policy of an enterprise determines which class of data items may be stored in public infrastructure, such as a computational cloud. Also, a security policy which is based on data item classification allows management of reports and determination who can have access to which data within an enterprise.

Methods and systems for automatic adaptive classification of data items, as provided by the embodiments presented herein, may be based on supervised machine learning, according to which the system can create a classification training set that will used by the system to automatically classify each additional data item that is created within the enterprise, based on the classification made on the training set. A training set can be created according to classifications made by a group of selected users, which may be employees that are distributed over the different departments or sites of an enterprise or organization. Such selected users can be asked to classify their own data items for a relatively short time period, in order not to overload them and to make sure that their classification accuracy will be maintained until the occurrence of a new set of clustered features that has not been trained. These selected users can provide sufficient examples to the training set, in order to cover kinds of information in the enterprise. This eliminates the need of an IT administrator to manually create a training set as might be required for machine learning. In addition, the invention may be used to prepare a training set according to a set of features (generally related to the content and context of the classified items), rather than according to content only. This may yield a comprehensive training set which is generated adaptively by a plurality of users (which are the content owners in the enterprise) and therefore, is much more comprehensive than a training set that an IT administrator would be able to generate. Also, if there is a change in the classification criteria over time (for example, documents that were used to be classified should not be classified anymore and may be made public), this change will be reflected in the training set, and after sufficient classifications by a plurality of users, the system will start to automatically classify the same documents as public). This way, internal changes in the enterprise will be automatically reflected in the training set and the organizational classification policy will be changed accordingly, without any intervention of the IT administrator.

Automatic classification can be made based on mutual patterns and features of items from a training set and items to be classified. These patterns and features may include for example, the level of similarity of each data item to other data items that already have been classified by selected users and are included in the training set. Other similarity patterns may be email messages that are sent from similar sources, to similar destinations, or both. Other patterns may include templates that are reused by the same or similarly situated users, etc.

Patterns and features may include content similarities, layout similarities (such as header, footer, titles, tables with named columns, etc.), entities (such as names, addresses, dates, Social Security Number IDs, companies, etc.), locations (such as file location, directories, servers, shares, locations of users, locations of recipients, etc.), a source that generated the data (such as application name, process name, URL, user, computer, system, etc.), an organizational unit that created the data, a department to which a user who created a data item belongs, user directory attributes which can characterize a user or user's device, a user's geographic location, metadata (tags, fields, etc.), features that are categorized to content, meta data, and events, and/or parameters which brought the existence of the data item.

Particular embodiments for classification described herein are based on supervised machine learning such that a method or system can be able to accurately classify data items that have not been classified before, based on the training set classifications. Each data item can be unstructured data (such as a file, document, a web page, or an email) or to structured data (such as a record or an item in a database).

In one example, selected classifying users can upload Human Resources data to a specific shared folder, directory, or location (such as Microsoft SharePoint). The system can then automatically classify all data items uploaded to that location (by other users) as Human Resources data of the enterprise. If, for example, some public data items have been uploaded to that folder as well, the system can be able to identify them, based on content analysis. In certain cases when automatic classification may be incorrect, or have changed over time, users can have or be given the ability to overrule it and change the classification. This overruling can also be learned by the system, such that future classification will yield more accurate classifications.

Another classification criterion may be similarity of fields and metadata between classified and unknown data items. For example, it may be possible to classify based on field comparison, topic comparison, metadata comparison, and data structure comparison.

Accuracy of classification can be increased over time, based on learning from selected users classifying data items and enriching the training set. As a result, an organizational security policy of an enterprise can be dynamically created by the elected classifying users, without the need to overload them or burden other users or data creators.

According to another embodiment, the methods and systems provided herein may have or be provided with an initial knowledge even before training. Since some data items such as financial reports are similar in many enterprises, these type of data items or criteria may be included in a pre-defined training set or criteria. The system can then learn the appropriate classifications from the classifications made by selected users that belong to the training set and apply the learned classification to data items created or manipulated by other users in the enterprise.

Users selected to create, identify, or provide a training set may be elected from all users, or from a predetermined class of users, which are considered to be expert, competent, knowledgeable, and/or “content owners” in an enterprise.

As the system may use supervised machine learning, it is possible to assign weights to each user classification event in the training set, or even to the users, themselves, according to the reputation (i.e., the classification accuracy) of the classifying users, such that classifying users that have higher reputation will have higher weight that will be considered during the machine learning process when determining classification criteria.

Such a classification learning system may be dynamic and be used to easily make adaptations in response to changes in data classifications, changes in an enterprise, etc., such as adding new documents, new data items, new content, new storage locations, etc. Such dynamic and adaptive response to changing conditions and classifications dramatically improves both coverage and accuracy provided by the classification system.

For example, embodiments presented herein may include methods, systems, and computer program products for adaptive classification of data items in an enterprise, organization, and even by individuals. In such methods, a classification training set may be received. The classification training set may include a set of items which are associated with manual or automatic classification events made by a group of selected users. Each selected user may have designated a classification for each item of his control included in the classification training set. It may be determined from the classification training set a set of rules which can be used to classify unknown data items such that the classification of the unknown data items is consistent with the manual or automatic classification of the classification training set. Examples of such events may include (but not be limited to) an explicit rule that items placed in a specific storage location are to be classified as a particular data type. In such a case, particular embodiments may use the contents of the storage location as a training set to determine some criteria for determining the particular data type. The set of rules may be adaptively updated according to classifications made to additional data items by additional users. One or more data items that are manipulated by a second set of one or more users may then be automatically classified based upon the set of rules (which have been determined and/or updated).

The methods, systems, and computer program products for adaptive classification of data items as presented herein may also “learn” how to classify data items in more ways than simply intra-organization “crowdsourcing.” Embodiments may be provided wherein an initially trained classification system—already trained for particular data types—is provided and can be immediately useful to an organization and can be further trained with additional use. Further, classification systems may receive input from third-parties, service providers, and/or other outside sources which can provide classification information specific to particular data types or to augment information “learned” within an organization, itself.

Other embodiments provided herein can provide the ability for multiple organizations to leverage the collected classification data (e.g., “learning” and/or “wisdom”) of the multiple organizations. For example, two law firms may collaborate to share the classification information determined in each organization to augment and combine the classification information of each organization to include the information of both organizations. Such collaboration, for instance, may be effected, for instance, by classification services implements in the cloud and accessible to multiple organizations.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an architecture of a system in which embodiments of the invention may be implemented.

FIG. 2 illustrates an flowchart for an example method of performing an embodiment of the invention as described herein.

FIG. 3 illustrates an example of selected users providing data items for determination of classification criteria.

FIG. 4 illustrates classification criteria being applied to a data item in order to classify the data item.

### DETAILED DESCRIPTION

Embodiments presented herein relate to adaptive classification of data items in an enterprise. As noted above, classification may be used to determine proper access, visibility, and/or distribution of data items. Similarly, classification of data items and documents may facilitate such searching, sorting, categorization, etc., of the data and documents. Embodiments presented herein relate to methods, systems, and products which can facilitate the automatic classification of data items and documents such that the resulting classifications may be used by enterprises, individuals, organizations, systems, etc., in whatever beneficial applications which may be useful.

For example, embodiments presented herein may include methods, systems, and computer program products for adaptive classification of data items in an organization or enterprise. In such a method, for example, a classification training set may be received. The classification training set may include a set of items which are associated with manual or automatic classification events made by a group of selected users. Each selected user may have designated a classification for each item of his control included in the classification training set. It may be determined from the classification training set a set of rules which can be used to classify unknown data items such that the classification of the unknown data items is consistent with the manual or automatic classification of the classification training set. The set of rules may be adaptively updated according to classifications made to additional data items by additional users. One or more data items that are manipulated by a second set of one or more users may then be automatically classified based upon the set of rules (which have been determined and/or updated).

Embodiments of the present invention may be implemented in, comprise, or utilize a special purpose or general-purpose computer including computer hardware. Such computer hardware may include, for example, one or more computer processors, system memory, data storage, and data communication hardware and functionality as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable storage devices (i.e., physical storage devices) are items of manufacture (i.e., hardware) that store data and/or computer-executable instructions. Computer-readable media that carry computer-executable instructions are termed “transmission media” (and are distinct from data storage devices). Thus, by way of example, and not limitation, embodiments of the invention can comprise at least two distinctly different kinds of computer-readable media: computer storage devices and transmission media.

Computer storage devices may include RAM, ROM, EEPROM, CD-ROM or other optical disk storage, magnetic disk storage or other magnetic storage devices, or any other physical medium which can be used to persistently store data and/or program code means in the form of computer-executable instructions or data structures and which can be accessed by a general purpose or special purpose computer. Storage devices are hardware items (i.e., articles of manufacture) and do not include data transmission media such as wireless signals.

A network is defined as one or more data links that enable the transport of data between computer systems and/or modules and/or other electronic devices. When information is transferred or provided over a network or another communications connection (e.g., hardwired, wireless, electronic, optical, or any combination of communication connections) to a computer, the computer properly views the connection as a transmission medium. Transmissions media can include network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions, code, data, and/or data structures can be transferred from transmission media to computer storage media (or vice versa). For example, computer-executable instructions or data structures received over a network or data link can be buffered in RAM within a network interface module (e.g., a “NIC”), and then eventually transferred at a computer system to computer system RAM and/or to less volatile computer storage media such as magnetic or optical storage media. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, machine code, binaries, intermediate format instructions such as assembly language, source code which can be compiled into suitable machine code or binary format, and/or source code which can be executed within a runtime environment.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will also appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, smartphones, tablet computers, PDAs, pagers, routers, switches, and other systems and platforms as are known in the art. The invention may also be practiced in distributed, networked, and cloud-based computing environments where local and remote computer systems, which are linked (either by hardwired data links, wireless data links, electronic data links, optical data links, or by any combination of data communication links) through a network, may each perform some or all computing tasks. In a distributed, networked, and/or cloud-based computing system environment, portions of executable code and/or program modules may be located in both local and remote memory storage devices and may be executed in both local and remote systems.

Classifications of data items may be important for many and diverse reasons. Classifications may include, for example, designations associated with the nature of various data items. Such classification designations may include, for example, business information, technical information, customer information, health care information, personal information, confidential or secret information, encrypted information, data which should be encrypted, public information, among many others.

A possible solution to classification of data and/or data items is to require that each user that creates a data item (which can be a document, file, mail, a database record, etc., whether structured or unstructured) should provide a classification for the data item. However, it is can be problematic to ensure that each user will actually classify each and every document created, since this is totally dependent on the user, especially considering some users may be low level employees or temporary employees. Further, no all users would have the knowledge, be competent to, or be qualified to determine and designate a correct classification for data items. Also, this solution may time consuming, costly, and otherwise wasteful. The accuracy of this existing solution may also be less than desired due to cultural considerations, education levels, effects on business productivity, and misjudgment of the classifying user.

Another possible solution to classification may be to use automatic classification, based on content analysis of data item attributes, content, location, metadata, etc. In such a solution, if a data item contains some pre-determined content criteria such as specified data types such as credit card numbers, bank account numbers, phone numbers, email addresses, etc., these data items may be associated with a classification within particular appropriate categories, such as banking information, customer details, technical data, etc. Such pre-determined content criteria may be supplied by a content expert, security analyst, IT administrator, or other such administrator or person of an organization. However, this solution may not always yield accurate results since, for instance, content may not always be real (for example, it may be dummy content for testing purposes) or may be anonymous and therefore, not need to be confidential. Such classification based on pre-determined content criteria may yield an unacceptable number of false-positive results. This solution may also provide inaccurate results because it may not be adapted to an organizational structure of an enterprise or organization, since classification is subject to the judgment of an IT administrator (for example) and there may be no one that actually knows all business processes and content types that can identify classification of data and result in the proper classification of data items.

Another possible solution to classification of data items may be to use predetermined folders, directories, or data storage locations which contain a specific class (such as financial reports), and classify each data item according to its level of similarity to other items in each folder or location. Such a solution may be problematic and difficult to implement in organizations that are distributed over different logical, physical, or virtual locations. This solution may also demand substantial effort from IT administrators and personnel of the organization. Such a solution would also be based on a training set of data items created by an IT administrator or other provider which may be limited and not encompass all criteria or document types or data items which should result in a particular classification.

Another possible solution to classification of data items may be to use machine learning technologies. Such a solution would include an administrator collecting a training set of existing data or data items which are properly identified as belonging to a particular classification (or classifications). A scanning and analysis process through execution of machine learning algorithms train the system to identify data items with appropriate similarities. This solution may also cumbersome as it requires an administrator to manage such a process and it can be problematic to identify each and every class of data and provide an appropriate training set for each classification.

An object of embodiments described herein may be to provide methods, systems, and computer program products for adaptive classification of data items, which are independent of the willingness, competence, and cooperation of every user, does not require involvement of an IT administrator to pre-define classification policies which will be applied to users and/or data items, and may be able to supply an IT administrator suggested classification rules for approval before deployment.

Another object of embodiments described herein may be to provide methods, systems, and computer program products for automatic adaptive classification of data items, which is not time consuming and is easy to implement.

Another object of embodiments described herein may be to provide methods, systems, and computer program products for automatic adaptive classification of data items, which is adapted to an organizational structure of an organization or enterprise, without requiring all or most users and an IT administrator (or other administrator) to be a necessary part of the classification process. Other objects, benefits, and advantages of the embodiments as described herein will become apparent throughout the description.

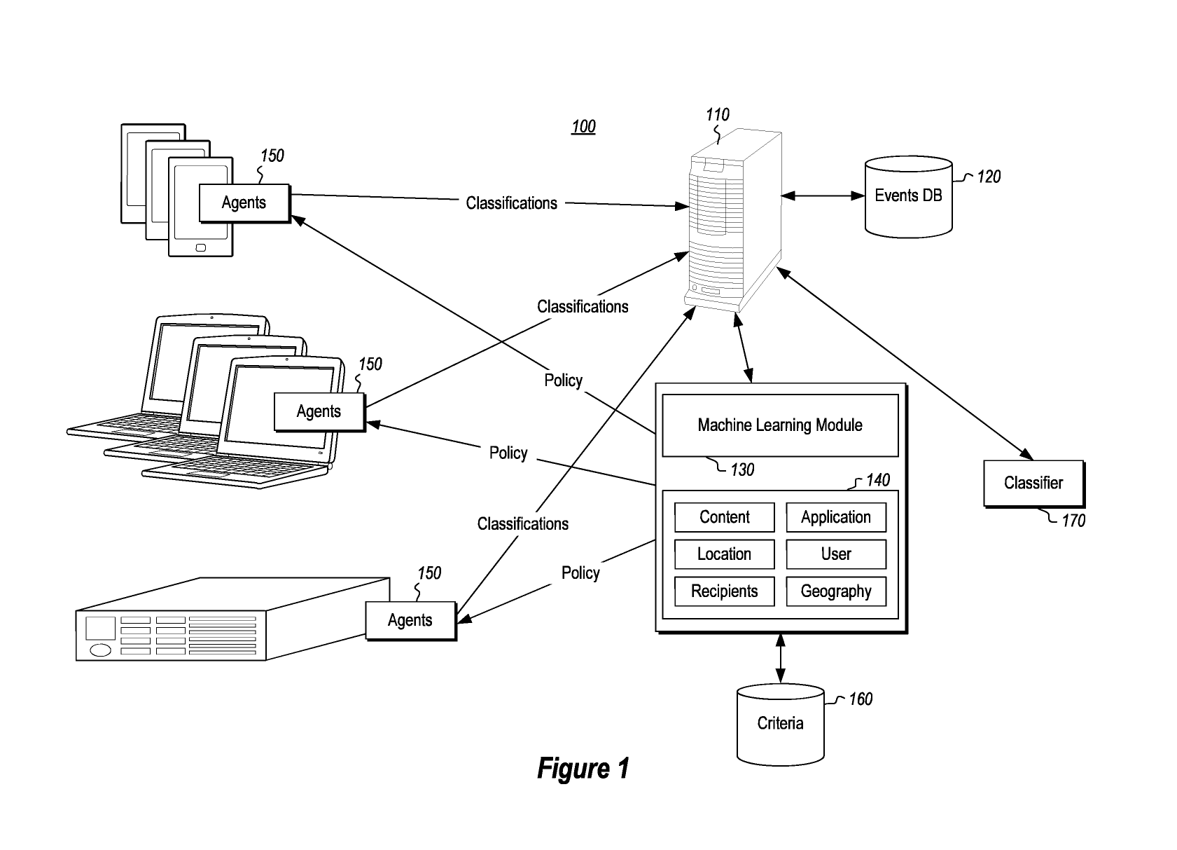

FIG. 1 illustrates an example computer architecture that facilitates the adaptive classification of data items. Referring to FIG. 1, a computer architecture 100 for adaptive classification of data items may include each of a number of components. Computer architecture 100 may include each of a classification system 110, an events and training item database 120, and a machine learning module 130. The machine learning module 130 may analyze events and training data items and create a set of rules, criteria, or knowledge pertaining to classification of data items including (but not limited to) content, applications, locations, users, recipients, and geography. The criteria created by the machine learning module 130 may be stored in a criteria repository 160. The architecture 100 may also include agents 150 which may be deployed upon various and distinct computing platforms such as smartphones, computer systems, and server systems which can further aid, implement, and facilitate the methods and functionality described herein. Such agents 150 may be implemented in various forms including modules embedded within or plugins to office productivity software such as word processors, email clients, web browsers, spreadsheet applications, presentation applications, among others. Agents 150 may also be implemented as software or modules included in backbone systems such as operating systems and file systems. Such agents 150 may also be functionality or functional modules packaged and comprised within other useful software such as office productivity software such as word processors, email clients, web browsers, spreadsheet applications, presentation applications, etc. The architecture 100 may also comprise a classifier 170 which applies the criteria 160 determined by the machine learning module 130 to received data items to determine a classification for such data items. (So, the architecture 100 may receive data items classified by selected users and may also classify data items which may or may not have been classified by other users.) In such a way, the architecture 100 provides for an ongoing “online” system which continually over time can both improve and augment its criteria for classifying data items and also continually over time apply a current set of criteria to data items to provide a classification of those data items consistent with the current criteria.

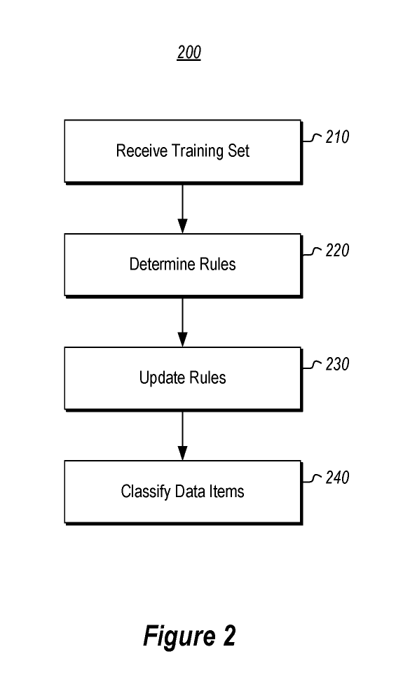

In one embodiment, a method may be performed for the adaptive classification of data items. Such a method 200 is illustrated in FIG. 2. Method 200 includes receiving 210 a classification training set. The classification training set can comprise a set of items associated with manual or automatic classification events made by a group of selected users, each item in the set of items having been designated as belonging to a particular classification by a selected user while manipulating the each item. (As used herein, “manipulate” or “manipulating” is used to denote creating, opening, reading, accessing, moving, emailing, copying, editing, etc. Likewise, a “data item” is used to connote a file, database record or entry, email message, etc., or other unit of data.)

Users with certain skills, knowledge, or credentials may be selected to provide data items for a training set for determining classification rules. Such a selected set of users may produce a set of documents which have been classified by the selected users as belonging to or associated with a particular classification. A set of data items may be received from such a set of selected users which have designated the data items as belonging to or associated with a particular classification.

In some embodiments, users, such as the selected users, may be assigned a reputation, knowledge, or skill value. Such a value may be determined by receiving a designation of such a value from an expert or authority or may be determined automatically by the system by comparing the user's classification of data items to the classification of the same data items by other users or by automatic classification by the system. Such a reputation, knowledge, or skill value may then be used as additional input to the system to weigh (i.e., give weight or adjust) a value of the classification of a data item which had been assigned by the user. In this fashion, a user's designation of particular classifications may be given more or less weight in determining the rules for future classification of unclassified data items based upon the user's skill value in assigning that particular classification. It is also possible, that a user may be assigned different skill values for different classifications. For example, a particular user may be highly skilled (e.g., skill level 98/100) in determining if a data item has technical content but have a low skill value (e.g., skill level=20/100) in determining if a data item has sensitive marketing, financial, or business content. In this fashion, in some embodiments, some users may be banned from classifying data. Such preclusion of a user providing self-assigned classifications may be effected by associating a “banned” tag with the user or assigning a low skill value (e.g., 0/100) to the user

The method 200 also includes determining 220 from the classification training set a set of rules which can be used to classify unknown data items such that the classification of the unknown data items is consistent with the manual or automatic classification of the classification training set.

Machine learning software or a machine learning module (as is known in the art), such as module 130, may analyze the data items in the training set to determine a set of rules, characteristics, or criteria which may be applied to other, unclassified data items, to determine whether the unclassified data items share a sufficient set or amount of common characteristics with the training set to be determined to be classified with the same classification as the training set.

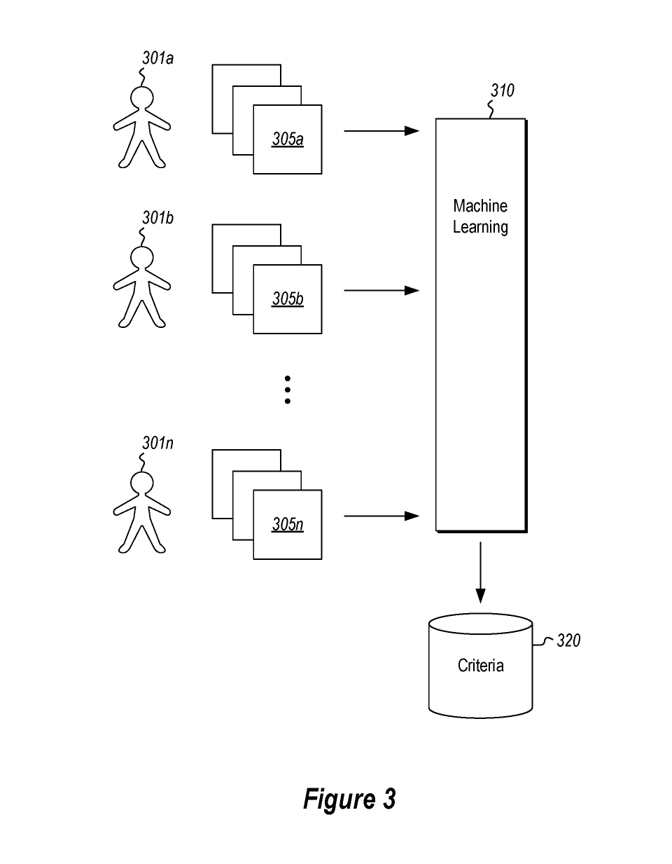

As is illustrated in FIG. 3, a set of selected users, 301a-301n, can produce data items, 305a-305n, respectively, which are provided to the machine learning software of module 310. Data items 305a-305n have been identified by the selected users 301a-301n as being properly classified as one or more particular classifications. The machine learning module may then analyze the receive data items, 305a-305n, and determine associated criteria 320 which may then be used to determine whether a future, unclassified, data item should be classified as belonging to one or more of the particular classifications which had been identified in the data items 305a-305n by selected users 301a-301n.

In some embodiments, an initial knowledge base may be incorporated into the determination of the set of rules, characteristics, or criteria. In such a fashion, certain initial rules, characteristics, or criteria may be received which can be used as an initial basis and then the machine learning module (or other system) may use the training set to augment and/or adapt the initial rules, characteristics, or criteria to produce a more accurate set of rules, characteristics, or criteria which may be applied to other, unclassified data items, to determine an appropriate classification for those unclassified data items.

The method 200 also includes adaptively updating 230 the set of rules, according to classifications made to additional data items by additional users. For instance, one or more of selected users 301a-301n may produce additional data items identified as belonging within a particular classification and the machine learning module 310 may analyze the additional data items and adapt and augment the criteria 320 to reflect and include the newly analyzed additional data items.

The machine learning module may determine an initial set of rules, characteristics, or criteria which may be applied to other, unclassified data items, to determine whether the unclassified data items share a sufficient set or amount of common characteristics with the training set to be determined to be classified with the same classification as the training set. The method may also include incrementally receiving additional data items which have been classified by additional users (selected users or otherwise) and, using these additional classified data items, may adaptively augment and update the set of rules, characteristics, or criteria. In such a fashion, over time, the set of rules, characteristics, or criteria may be adaptively updated by including increasingly more example data items in addition to an initial training set. The set of rules, characteristics, or criteria may in this fashion become increasingly more accurate in being useful and able to determine whether an unclassified data item should be designated with a particular classification.

The method 200 also includes automatically classifying 240, based on the set of rules, one or more data items that are manipulated by a second set of one or more users.

As a set of rules, characteristics, or criteria has been created (and incrementally updated), this set of rules, characteristics, or criteria may then be applied to other, unclassified data items, to determine whether the unclassified data items should be designated as being classified with the same classification(s) as the training set.

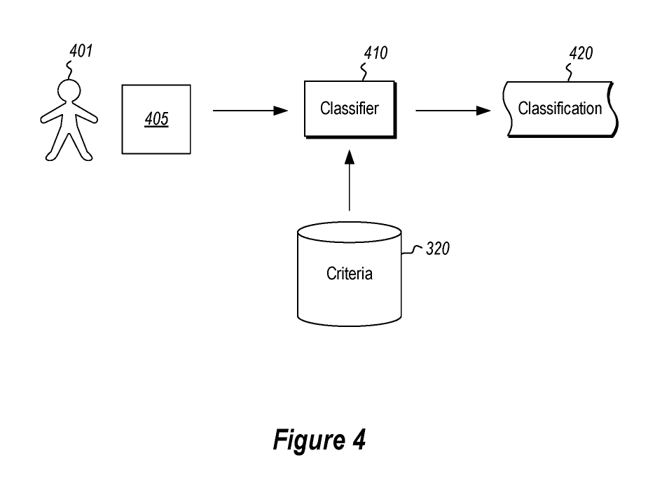

For instance, a classifier such as classifier 410 of FIG. 4 may receive an unclassified data item 405 which had been created, accessed, read, and/or manipulated in some way by user 401. User 401 may be a user other than a selected user or may be a selected user who has created or manipulated a data item but did not classify it. The classifier 310 may then utilize the criteria 320 (having been previously produced by machine learning module 310), apply criteria 320 to the data item 405, and produce a classification 420 (or classifications) which is in accordance with criteria 320.

Classification of a data item may be made based on mutual patterns which have been identified from the training set and the data item being classified. Such patterns may include a level of similarity of each data item to other data items that already have been classified. The patterns may also include email messages that are sent from similar sources to similar destinations. The pattern may include templates that are reused by common users. And the patterns may also include a level of similarity of fields and metadata between classified and unknown data items.

Classification may be made based on a common or shared storage location of data items and/or content analysis of data items.

Classification may be made based on a similar source or a similar destination for transmitted data. Classification may also be made based on a similar source (i.e., creator or provider) for a data item. Classification may also be made based on the content or content type of a data item. Classification may also be made based on the internal or external layout of a data item or the structure of the data within a data item. Classification may also be made based on a group or organization to which a user of a data item (or data user of data arising from a data item) belongs. Classification may also be made based on metadata within or associated with a data item. Classification may also be made based on a template which may have been used to create or associated with a data item.

Classifying a data item may include, for example, attaching a metadata tag to the data item which identifies the classification of the data item. Classifying a data item may also include recording an entry in a data base which identifies both the data item and the designated classification.

Classifying data items may include determining and/or assigning confidence levels to the classification of a data item. For example, given a particular training set or update of the set of rules, characteristics, or criteria which may be applied to an unclassified data item to determine a classification for the unclassified data item, a confidence level or value may also be determined. The confidence level or value may identify or indicate a particular confidence as to whether or not the determined classification of the data item is, indeed, correct based on the set of rules. For example, a confidence level of 95% may indicate a high confidence or likelihood that the classification is correct but a confidence level of 45% may indicate a low confidence or likelihood that the determined classification is correct.

Adaptively updating the set of rules, characteristics, or criteria, as discussed above, may also include receiving an overrule of an automatic classification of a data item. In such a case, a data item may be classified by the application of a current set of rules, characteristics, or criteria but then a notification or feedback may be received that the classified data item is not to be so classified (i.e., overruled). Such an overrule of a classification may then be used as a basis for updating the set of rules, characteristics, or criteria which will be applied toward future classifications of data items. In some embodiments, an “overrule” is the same as and can be effected by a user, such as a selected user, providing a data item with a “NOT” classification. In other words, in such a scenario, a user may provide a data item to the machine learning module 310 identified as “NOT classification X” and the module 310 can analyze the data item and incorporate into the set of rules, characteristics, or criteria that characteristics of the data item are to be considered as precluding classification of similar data items which may be subsequently received as being in classification X.

Confidence scores and thresholds may also be incorporated. This may include at least two scores. There may be a confident score measuring the quality of the classifier, itself. This would be an indication of how good the classifier is at determining classifications. Machine learning, as discussed and applied herein, may use such measures as Accuracy, Precision, and Recall to assign a score to the classifier, itself, during a training phase. This can provide information as to how much to trust the determinations of the classifier. Given such a score, an administrator, for instance, could set thresholds for how a classifier may be used such as, for example, for recommendations only (which may require confirmation by a user) or for automatic classification (which can be trusted or applied without a user's approval). Another confidence score may be a score a classifier may determine for an individual or particular data item. In this case, the classifier may indicate a value the classifier has determined as to how confident the classifier is that a particular data item actually falls within an identified classification type.

For instance, if a classification is determined and is determined to have a confidence level of greater than 90%, then the data item may be classified as determined. However, if a classification is determined but it is determined to have a confidence level of less than 90%, then the data item may be designated to be classified as had been determined. Thresholds may be automatically set based upon a statistical analysis or may be manually set by an administrator. There may also be multiple thresholds for particular classifications. For instance, a “secret” classification may have a upper threshold of 90% and a lower threshold of 50%. In this example, if a data item is determined to be “secret” with a confidence of 90% or more, the data items is designated as “secret.” If the data item is determined to be “secret” with a confidence of 60% (i.e., between the upper 90% and lower 50% thresholds), the data items is designated as “potentially secret” and may, for example, be designated (and classified) as requiring additional analysis. Continuing the example, if a data item is determined to be “secret” with a confidence of 40% (i.e., below the lower 50% threshold), the data item may be designated as “not secret.”

Confidence levels may also be incorporated into methods for training and augmenting classification criteria. When confidence level is low (either for the classifier, itself, or for an individual data item), a system may ask an end user to manually select or confirm a classification. If a confidence level is sufficiently high, a system may forgo requesting end user feedback and automatically supply a classification or classification recommendation. Additionally, a system my prompt a user for classification of or the confirmation of a classification for a data item which may have an ambiguous determination of classification. For example, a data item may be directly on the “border” of a decision boundary of one classification or another and the system may refer the classification or confirmation of a recommended classification to an administrator, an identified expert, or an end user.

When a data item is classified, the data item may be identified or marked as having been so classified. The determined classification (or classifications) may be indicated in a data tag added to, appended to, or associated with the data item, the tag identifying the determined classification (or classifications). The identified classification (or classifications) may be indicated in metadata added to, appended to, or associated with the data item, the metadata identifying the determined classification (or classifications). The identified classification (or classifications) may also be indicated in data recorded elsewhere but associated with the data item. For instance, such data associated with the data item may be stored by a file system, email system, database, or otherwise, and associated with the data item by the file system, email system, database, etc. Such tags, metadata, data, etc., in addition to identifying classification(s), may also include information recording confidence levels, date of classification, etc.

Once classified, there may be policies which dictate handling of classified data items. For instance, a “high importance” or “secret” data item may be required to be or automatically encrypted or, in another embodiment, may be moved for storage in a secure data storage location. Such policies may be defined by an administrator and enforced either manually or automatically by a classifier such as classifier 410.

As described above, presented herein are methods, systems, and computer program products for adaptive classification of data items. The present invention may be embodied in other specific forms without departing from its spirit or essential characteristics. The described embodiments are to be considered in all respects only as illustrative but not restrictive. The scope of the invention is, therefore, indicated by the appended claims rather than by the foregoing description. All changes which come within the meaning and range of equivalency of the claims are to be embraced within their scope.

What is claimed:

1. A computer-implemented method for adaptive classification of data items in an enterprise, the method comprising:
receiving a classification training set, the classification training set comprising a set of items associated with manual or automatic classification events made by a group of selected users, each item in the set of items having been designated as belonging to a particular classification by a selected user while manipulating the each item;
determining from the classification training set a set of rules which can be used to classify unknown data items such that the classification of the unknown data items is consistent with the manual or automatic classification of the classification training set;
adaptively updating the set of rules, according to classifications made to additional data items by additional users; and
automatically classifying, based on the set of rules, one or more data items that are manipulated by a second set of one or more users.

2. A method according to claim 1, wherein the automatic classification is made, based at least in part on mutual patterns identified from the training set and items to be classified.

3. A method according to claim 2, wherein the patterns include one or more of:
a level of similarity of each data item to other data items that already have been classified;
a similar source and/or destination for transmitted data;
a source of a data item;
data item content;
layout or structure of data within a data item;
geo location;
a group to which a data user belongs;
data item metadata;
templates that are reused by common users; and
a level of similarity of fields and metadata between classified and unknown data items.

4. A method according to claim 1, wherein the automatic classification is made, based on one or more of:
a shared storage location; and
content analysis.

5. A method according to claim 1, further comprising receiving an overrule of an automatic classification, such that the overruled classification is a basis for additional updating of the set of rules.

6. A method according to claim 1, further comprising incorporating an initial knowledge base into the determination of the set of rules.

7. A method according to claim 1, further comprising:
determining a reputation value for a classifying user; and
assigning a weight to a classification based on the reputation value of the classifying user.

8. A computer system for adaptive classification of data items in an enterprise, the system comprising one or more computer processors and data storage having encoded therein computer-executable instructions which, when executed upon the one or more processors, cause the system to perform a method comprising:
receiving a classification training set, the classification training set comprising a set of items associated with manual or automatic classification events made by a group of selected users, each item in the set of items having been designated as belonging to a particular classification by a selected user while manipulating the each item;
determining from the classification training set a set of rules which can be used to classify unknown data items such that the classification of the unknown data items is consistent with the manual or automatic classification of the classification training set;
adaptively updating the set of rules, according to classifications made to additional data items by additional users; and
automatically classifying, based on the set of rules, one or more data items that are manipulated by a second set of one or more users.

9. A system according to claim 8, wherein the automatic classification is made, based at least in part on mutual patterns identified from the training set and items to be classified.

10. A system according to claim 9, wherein the patterns include one or more of:
a level of similarity of each data item to other data items that already have been classified;
a similar source and/or destination for transmitted data;
templates that are reused by common users; and
a level of similarity of fields and metadata between classified and unknown data items.

11. A system according to claim 8, wherein the automatic classification is made, based on one or more of:
a shared storage location; and
content analysis.

12. A system according to claim 8, further comprising receiving an overrule of an automatic classification, such that the overruled classification is a basis for additional updating of the set of rules.

13. A system according to claim 8, further comprising incorporating an initial knowledge base into the determination of the set of rules.

14. A system according to claim 8, further comprising:
determining a reputation value for a classifying user; and
assigning a weight to a classification based on the reputation value of the classifying user.

15. A computer program product for enabling the adaptive classification of data items in an enterprise, the computer program product comprising one or more data storage devices having encoded therein computer-executable instructions which, when executed upon one or more computer processors, cause the processors to be configured to perform a method comprising:
receiving a classification training set, the classification training set comprising a set of items associated with manual or automatic classification events made by a group of selected users, each item in the set of items having been designated as belonging to a particular classification by a selected user while manipulating the each item;
determining from the classification training set a set of rules which can be used to classify unknown data items such that the classification of the unknown data items is consistent with the manual or automatic classification of the classification training set;
adaptively updating the set of rules, according to classifications made to additional data items by additional users; and
automatically classifying, based on the set of rules, one or more data items that are manipulated by a second set of one or more users.

16. A computer program product according to claim 15, wherein the automatic classification is made, based at least in part on mutual patterns identified from the training set and items to be classified.

17. A computer program product according to claim 16, wherein the patterns include one or more of:
a level of similarity of each data item to other data items that already have been classified;
a similar source and/or destination for transmitted data;
templates that are reused by common users; and
a level of similarity of fields and metadata between classified and unknown data items.

18. A computer program product according to claim 15, wherein the automatic classification is made, based on one or more of:
a shared storage location; and
content analysis.

19. A computer program product according to claim 15, further comprising receiving an overrule of an automatic classification, such that the overruled classification is a basis for additional updating of the set of rules.

20. A computer program product according to claim 15, further comprising incorporating an initial knowledge base into the determination of the set of rules.
